(19) United States
(12) Patent Application Publication
(10) Pub. No.: US 2008/0197954 A1
(43) Pub. Date: Aug. 21, 2008

(54) ARRANGEMENT FOR COOLING A GRADIENT COIL

(76) Inventors: Peter Groeppel, Erlangen (DE); Juergen Huber, Erlangen (DE); Johann Schuster, Oberasbach (DE); Lothar Schoen, Neunkirchen (DE); Stefan Stocker, Grossenseebach (DE)

Correspondence Address: SCHIFF HARDIN, LLP;PATENT DEPARTMENT, 6600 SEARS TOWER, CHICAGO, IL, 60606-6473, US

(21) Appl. No.: 12/033,118

(22) Filed: Feb. 19, 2008

(30) Foreign Application Priority Data
Feb. 19, 2007 (DE) 10 2007 008 122.9

(51) Int. Cl. H01F 5/06

(52) U.S. Cl. 336/57

(57) ABSTRACT

An arrangement for cooling a gradient coil has cooling tubes for coolant transport arranged for heat dissipation from coil positions of the gradient coil. Insulator plates for electrical insulation are arranged both between the coil positions and between the coil positions and the respective cooling tubes. The insulator plates include fabric layers (prepregs) that are impregnated with a reaction resin. The insulator plates exhibit a heat conductivity of greater than or equal to 0.5 W/mK.

### BACKGROUND OF THE INVENTION

1. Field of the Invention

The invention concerns an arrangement for cooling a gradient coil.

2. Description of the Prior Art

A gradient coil system of a magnetic resonance apparatus has three magnetic field coils that are aligned along three spatial axes.

The gradient coil system is usually cast in a resin matrix using epoxy resin in order to ensure desired mechanical and electrical properties.

In the gradient coils, gradient currents of several hundreds of amperes at electrical voltages of up to 200 volts are typical, such that large heat quantities arising due to power losses must be discharged or dissipated.

Water that is provided for cooling the gradient coils by heat dissipation. For this purpose cooling tubes that are embedded in the resin are provided between individual coil levels of the gradient coil. Several hundreds of meters of cooling tubes that are arranged in parallel cooling circuits are typically used per gradient coil.

Insulator plates that formed of a glass fabric epoxy resin laminate are additionally arranged on the one hand between the coil levels as well as between the individual coils and the respectively associated water cooling. Depending on the thickness, the glass fabric epoxy resin laminate have a number of layers known as “prepreg” layers that are formed by pressing at increased temperature and pressure.

Fabric layers that are impregnated with a reaction resin are designated as “prepregs”. The reaction resin is in what is known as the B-state, meaning that it is partially chemically pre-reacted. If the reaction resin is pressed at higher temperature, resin in the fabric layer re-melts so that the individual fabric layers are glued with one another—the reaction resin hardens (cures) into what is known as a “duroplast”. The heat conductivity of insulator plates embodiment the prepreg layers is approximately 0.3 W/m*K to 0.4 W/m*K, such that these insulator plates represent a decisive heat resistance that hinders the transport of heat away from the gradient coil to the water cooling.

Respective remaining coil interstices are filled with a sealing compound, with an epoxy resin cured with acid anhydride being used as a sealing compound, for example. This typically includes approximately 65% quartz powder by weight, such that the sealing compound has a heat conductivity of approximately 0.8 W/m*K to 0.9 W/m*K.

FIG. 4 shows a cross-section of a cooling arrangement according to the prior art.

Cooling tube windings KSW are embedded in epoxy resin Epoxy. A first coil winding SW1 and a second coil winding SW2 that form a heat source WQ are separated from one another by poorly heat-conductive insulator plates ISO. An additional insulator plate ISO is provided between the second coil winding SW2 and the epoxy resin Epoxy. A heat flow WF formed by the two heat sources WQ1, WQ2 should be dissipated from the two coil windings SW1, SW2 directly to the cooling tube windings KSW.

An object of the present invention to provide an arrangement for cooling a gradient coil with which an improved dissipation of heat can be achieved while also achieving a high-grade electrical insulation between the gradient coil windings.

The above object is achieved in accordance with the present invention by an arrangement for cooling a gradient coil in which cooling tubes for coolant transport are arranged for heat dissipations from coil positions of the gradient coil, and wherein insulator plates for electrical insulation are arranged both between the coil positions and between the coil positions and the respective cooling tubes, and wherein the insulator plates are formed by fabric layers (prepegs) that are impregnated with a reaction resin, and wherein the insulator plates exhibit a heat conductivity of greater than or equal to 0.5 W/mK.

The inventive arrangement uses insulator plates that include one or more prepreg layers or prepreg fabric layers impregnated with a reaction resin. The insulator plates thereby exhibit an increased heat conductivity relative to customary glass fiber-reinforced insulator plates—the heat conductivity is preferably ≧0.5 W/mK.

The increased heat conductivity of the insulator plates is achieved in that the prepreg fabric layers comprise fibers (fiber rovings, individual fibers or short fibers) with a heat conductivity increased relative to glass fibers.

In an embodiment of the invention, the fabric layers include aluminum oxide fibers.

In a preferred development, at least two prepreg fabric layers are used, wherein a filling material that conducts heat well is arranged between the individual prepreg layers.

Alternatively or in addition to this, the prepreg layers are impregnated with a resin that forms the filling material that conducts heat well.

In a preferred development, particulate or fibrous or plate-like materials are used as a filling material, for example quartz or aluminum oxide or aluminum nitride or coated or encased aluminum nitride or titanium oxide as well as boron nitride.

In a preferred embodiment the filling material of the prepreg layers is coated or encased with a resin before use, wherein the resin is compatible with the prepreg layers and reacts with these.

In a preferred embodiment the filling materials are also used to fill remaining interstices (known as “gussets”) at intersection points of the fiber rovings. The laminate-resin proportion is thereby advantageously reduced and the heat conductivity is increased.

In a further embodiment of the invention, filling materials are used that exhibit nanoparticles, for example natural products such as quartz, aluminum oxide, titanium oxide or boron nitride.

Due to their small size, these nanoparticles are not subject to any filtration effects, such that a migration of the nanoparticles between the filaments of the fiber rovings is enabled. This leads to an increased homogeneity of the filling material distribution and thus to an improved mechanical or, respectively, electrical durability of the total coil system.

In a further embodiment of the invention, mixtures of filling materials with regard to the type and/or the particle shape are used.

In a further preferred embodiment, the described fiber materials are also used in conventional prepreg fabric layers that are based on glass fibers or on basalt fibers.

In a further preferred embodiment, resins are known as “liquid crystal” resins (for example epoxy resins) are used for impregnation. These are characterized by a high heat conductivity.

An effective, improved cooling of coil windings of the gradient coil is achieved via the inventive arrangement.

An operation of the gradient coil even given high current strengths is therewith enabled without impermissibly increasing a predetermined maximum temperature.

Temperature spikes in the region of closely wound conductive layers of the gradient coils are avoided via the inventive arrangement, such that a more uniform temperature distribution and lower mechanical stresses in the coil structure are enabled.

The inventive arrangement satisfies a requirement for the construction of high-capacity coils in the smallest structural space since the inventive arrangement for cooling exhibits only a small space requirement.

### BRIEF DESCRIPTION OF THE DRAWINGS

FIG. 1 shows a first embodiment of the inventive arrangement with two fabric layers.

FIG. 2 shows a second embodiment of the inventive arrangement with two fabric layers.

FIG. 3 is a cross-section of the inventive cooling arrangement.

FIG. 4 is a cross-section of a cooling arrangement described above according to the prior art.

### DESCRIPTION OF THE PREFERRED EMBODIMENTS

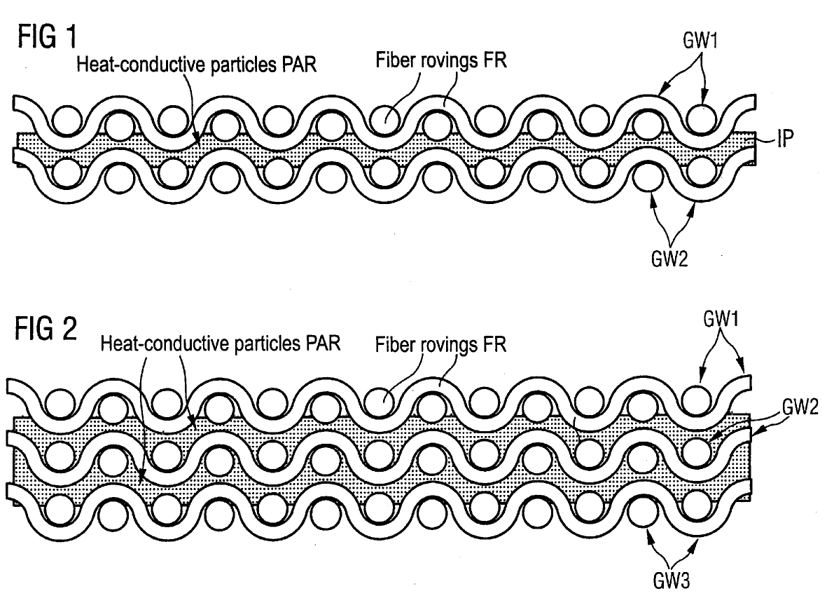

FIG. 1 shows a first embodiment of the inventive arrangement with a first fabric layer GW1 and with a second fabric layer GW2.

The two fabric layers GW1 and GW2 include respective fiber rovings FR and are separated from one another by an insulator plate IP that comprises the inventively designed filling material.

Here, for example, the filling material includes particles PAR that, for example, comprise quartz or aluminum oxide or aluminum nitride or coated aluminum nitride or titanium oxide or boron nitride.

FIG. 2 shows a second embodiment of the inventive arrangement with a first fabric layer GW1, with a second fabric layer GW2 and with a third fabric layer GW3.

The third fabric layers GW1, GW2 and GW3 includes respective fiber rovings and are separated from one another by an inventively designed filling material.

Here, for example, the filling material again includes particles PAR that, for example, include quartz or aluminum oxide or aluminum nitride or coated aluminum nitride or titanium oxide or boron nitride.

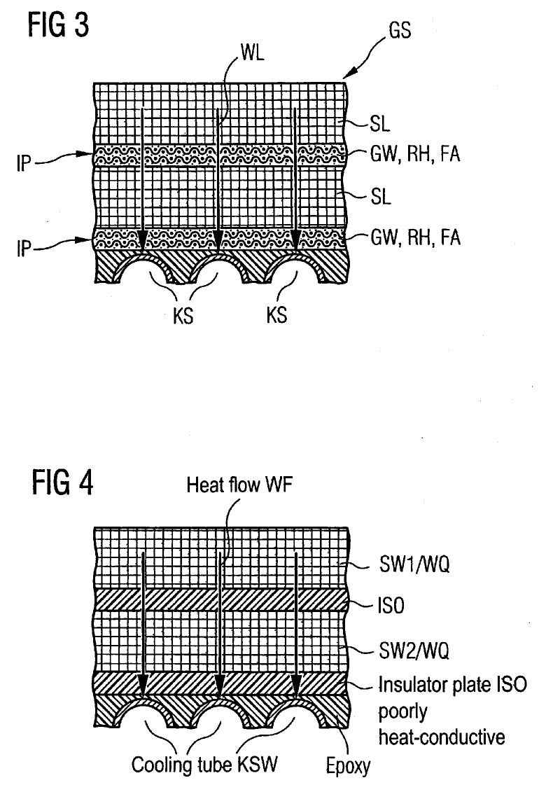

FIG. 3 shows a cross-section of the inventive cooling arrangement.

In a gradient coil GS cooling tubes KS for coolant transport are arranged for heat dissipation WL from coil positions SL of the gradient coil GS.

For electrical insulation, insulator plates IP are arranged both between the coil positions SL and between the coil positions SL and the respective cooling tubes KS.

The insulator plates IP comprise fabric layers GW (known as prepregs) that are impregnated with a reaction resin RH.

The prepreg fabric layers GW comprise fibers FA that exhibit a heat conductivity increased relative to glass fibers.

Although modifications and changes may be suggested by those skilled in the art, it is the intention of the inventors to embody within the patent warranted hereon all changes and modifications as reasonably and properly come within the scope of their contribution to the art.

We claim as our invention:

1. An arrangement for cooling a gradient coil comprising:
a gradient coil exhibiting a plurality of coil positions;
cooling tubes for cooling transport arranged for heat dissipation from the coil positions of the gradient coil;
insulator plates for electrical insulation arranged both between the coil positions and between the coil positions and the respective cooling tubes; and
said insulator plates comprising fabric layers impregnated with a reaction resin, and exhibiting a heat conductivity of greater than or equal to 0.5 W/mK.

2. An arrangement as claimed in claim 1 wherein said fabric layers comprise fibers with a heat conductivity that is greater than a heat conductivity of glass fibers.

3. An arrangement as claimed in claim 2 wherein said fabric layers comprise aluminum oxide fibers.

4. An arrangement as claimed in claim 1 comprising a heat conducting filler material arranged between at least two of said fabric layers.

5. An arrangement as claimed in claim 4 wherein said filling material is selected from the group consisting of particulate filling material, fibrous filling material, and plate-like filling material.

6. An arrangement as claimed in claim 4 wherein said filling material is selected from the group consisting of quartz, aluminum oxide, aluminum nitride, encased aluminum nitride, titanium oxide, and boron nitride.

7. An arrangement as claimed in claim 4 wherein said filling material is encased with a resin before placement between said at least two fabric layers, said resin encasing said filling material being compatible with said reaction resin in said fabric layers and reacting therewith.

8. An arrangement as claimed in claim 1 wherein said filling material comprises nanno particles.

9. An arrangement as claimed in claim 8 wherein said nanno particles are selected from the group consisting of quartz nanno particles, aluminum oxide nanno particles, titanium oxide nanno particles, and boron nitride nanno particles.

10. An arrangement as claimed in claim 1 wherein said fiber layers are impregnated with a resin comprising a heat-conducting filling material.

11. An arrangement as claimed in claim 10 wherein said filling material is selected from the group consisting of particulate filling material, fibrous filling material, and plate-like filling material.

12. An arrangement as claimed in claim 10 wherein said filling material is selected from the group consisting of quartz, aluminum oxide, aluminum nitride, encased aluminum nitride, titanium oxide, and boron nitride.

13. An arrangement as claimed in claim 10 wherein said filling material is encased with a resin before placement between said at least two fabric layers, said resin encasing said filling material being compatible with said reaction resin in said fabric layers and reacting therewith.

14. An arrangement as claimed in claim 10 wherein said filling material fills gussets between fiber rovings of said fabric layers.

15. An arrangement as claimed in claim 10 wherein said filling material comprises nanno particles.

16. An arrangement as claimed in claim 15 wherein said nanno particles are selected from the group consisting of quartz nanno particles, aluminum oxide nanno particles, titanium oxide nanno particles, and boron nitride nanno particles.

17. An arrangement as claimed in claim 1 wherein said insulator plates additionally comprise fibers selected from the group consisting of glass fibers and basalt fibers.
